(19) United States
(12) Patent Application Publication
(10) Pub. No.: US 2020/0254870 A1
(43) Pub. Date: Aug. 13, 2020

(54) TWO-SPEED AUTOMATIC MECHANICAL TRANSMISSION ELECTRIC AXLE ASSEMBLY

(71) Applicant: DONGFENG DANA AXLE CO., LTD., Xiangyang, Hubei (CN)

(72) Inventors: Buliang ZHANG, Xiangyang (CN); Dean GAO, Xiangyang (CN); Shengli HU, Xiangyang (CN); Chennan ZHANG, Xiangyang (CN); Qinggang SHAO, Xiangyang (CN)

(21) Appl. No.: 16/642,871

(22) PCT Filed: Aug. 31, 2018
(86) PCT No.: PCT/CN2018/103415

§ 371 Date: Feb. 27, 2020

(30) Foreign Application Priority Data
Aug. 31, 2017 (CN) 201710772616.4
Aug. 31, 2017 (CN) 201710775696.9
Aug. 31, 2017 (CN) 201721109237.9
Aug. 31, 2017 (CN) 201721110121.7

(51) Int. Cl. B60K 17/16; B60K 1/00

(52) U.S. Cl. CPC B60K 17/16; F16H 48/08; B60K 1/00

(57) ABSTRACT

Provided herein is an electric axle assembly including an axle housing; a motor/generator having an output shaft drivingly connected thereto, wherein the output shaft has an output gear rotatably mounted thereon; a differential assembly housed in a differential housing and drivingly connected to a pair of axle half shafts having a pair of wheels attached to the ends thereof; and a two-speed transmission housed in the axle housing and drivingly connected to the output gear and the differential assembly, wherein the output shaft drivingly connects the motor/generator to the differential assembly.

### RELATED APPLICATIONS

This application claims priority to and benefit of Chinese Utility Model Application CN201721110121.7 filed on Aug. 31, 2017, Chinese Invention Application No. CN201710775696.9 filed on Aug. 31, 2017, Chinese Utility Model Application CN201721109237.9 filed on Aug. 31, 2017 and Chinese Invention Application No. CN201710772616.4 filed on Aug. 31, 2017, which are herein incorporated in by reference.

### BACKGROUND

At present, a majority of the pure electric vehicles use the powertrain structures of a conventional internal combustion engine that include a driving motor, a drive shaft, a differential assembly, an axle shaft and wheel end. The differential has a fixed speed ratio that requires the driving motor to meet high performance requirements and maintain high maximum efficiency. Operating the driving motor outside its high efficiency range creates a waste of energy, which has a detrimental effect on the cruising range of the vehicle and makes it difficult to drive the motor selection and control costs.

At the same time, the traditional structure of a transmission used in an internal combustion engine vehicle is large and leads to efficiency losses. Additionally, the large size of each component making up the transmission will occupy space in the vehicle affecting the passenger capacity of the vehicle and the space available for the battery affecting the driving range of the vehicle.

To overcome the deficiencies of the prior art, the object of the present invention is to provide an integrated transmission and differential two-speed electric axle.

By integrating a two-speed transmission, the vehicle can drive at the speed where the motor operates in a high efficiency working range, improving the driving motor efficiency, reducing energy consumption, operate in drive and overdrive conditions suitable for most urban traffic conditions, while having a compact arrangement of the transmission to improve efficiency, enhance the capacity of the passenger compartment and increase the battery capacity of the compartment, thereby reducing the energy consumption per unit mass of the carrier.

To overcome the deficiencies of the prior art, it is an object of the present invention to provide a two-speed transmission integrated with a differential assembly and a conventional mechanical axle through depth integration into an electric axle assembly.

The integrated two-speed transmission allows the vehicle to operate the motor in a high-efficiency working range at the required speed, which improves the efficiency of the motor and reduces energy consumption. The cruising and overspeed provided by the assembly are sufficient for most urban traffic conditions.

Additionally, the compact structure of the assembly reduces the size of the transmission comparatively, increases the passenger capacity of the cabin and increases the battery capacity of the cabin, thereby reducing the energy consumption per unit load.

### SUMMARY

Provided herein is an electric axle assembly including: an axle housing; a motor/generator having an output shaft drivingly connected thereto, wherein the output shaft has an output gear rotatably mounted thereon; a differential assembly housed in a differential housing and drivingly connected to a pair of axle half shafts having a pair of wheels attached to the ends thereof; and a two-speed transmission housed in the axle housing and drivingly connected to the output gear and the differential assembly, wherein the output shaft drivingly connects the motor/generator to the differential assembly.

In some embodiments, the two-speed transmission includes a countershaft having a countershaft gear rotatably mounted thereon and a two-speed gear rotatably mounted on the countershaft, wherein the countershaft gear is meshingly engaged with the output gear.

In some embodiments, the differential assembly includes a first driven gear on rotatingly mounted on the axle half shaft, a second driven gear rotatingly mounted on the axle half shaft and a coupling sleeve, wherein the two-speed gear selectively meshes with the first driven gear and the second driven gear.

In some embodiments, the output shaft, the axle half shafts and the countershaft are parallel to each other.

In some embodiments, the electric axle assembly further includes a wheel end reducing gear set drivingly attached to the axle half shaft and the wheel.

In some embodiments, the wheel end reducing gear set is a planetary gear set.

### BRIEF DESCRIPTION OF THE FIGURES

Novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is a perspective view of a preferred embodiment of an electric axle assembly.

FIG. 2 is a partial view of the electric axle assembly of FIG. 1

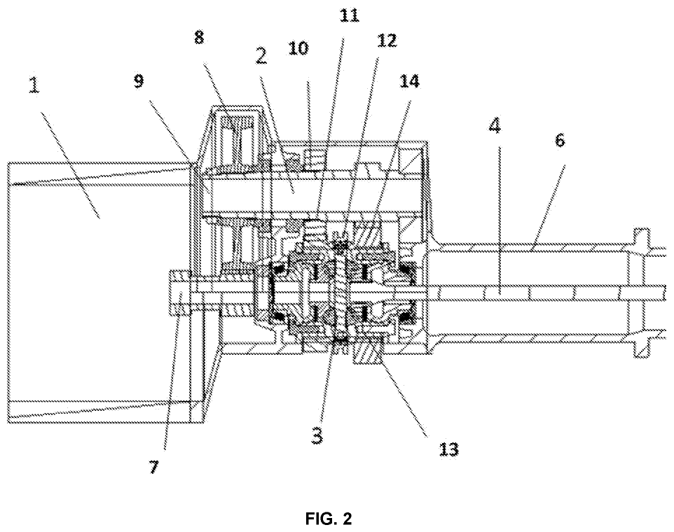

### DETAILED DESCRIPTION OF PREFERRED EMBODIMENTS

It is to be understood that the preferred embodiments may assume various alternative orientations and step sequences, except where expressly specified to the contrary. It is also to be understood that the specific assemblies, articles and features illustrated in the attached drawings, and described in the following specification are simply exemplary embodiments of the inventive concepts defined the appended claims. Hence, specific dimensions, directions, or other physical characteristics relating to the embodiments disclosed are not to be considered as limiting, unless expressly stated otherwise. Also, although they may not be, like elements in various embodiments may be commonly referred to with like reference numerals within this section of the application.

Provided herein is an electric axle assembly that integrates the functions of the traditional mechanical axles in the traditional electric vehicle drive unit and replaces them in structure and function by integrating a two-speed automatic transmission in the axle.

The present invention is based on the integration conventional power transmission structure of electric vehicles with a two-speed transmission and a conventional axle assembly to achieve a shift by two-speed automatic transmission with an electrically controlled shift execution unit. The assembly removes the conventional drive shaft and inputs power directly to a wheel through the axle half shaft.

The power of the motor/generator is transmitted to the wheel ends through a motor output gear, a two-speed transmission, a differential assembly, and a set of axle half shafts of an axle. The bevel gear of a conventional transmission is eliminated so that the input and output ends of the power are on the same axis, so the power output is smooth and efficient.

The two-speed automatic transmission keeps the motor/generator in a high-efficiency operating range, reducing energy consumption. The elimination of the drive shaft and bevel gear reduces the number of parts, making the assembly compact and lightweight, increasing the passenger compartment space and battery layout space, improving product suitability and competitiveness.

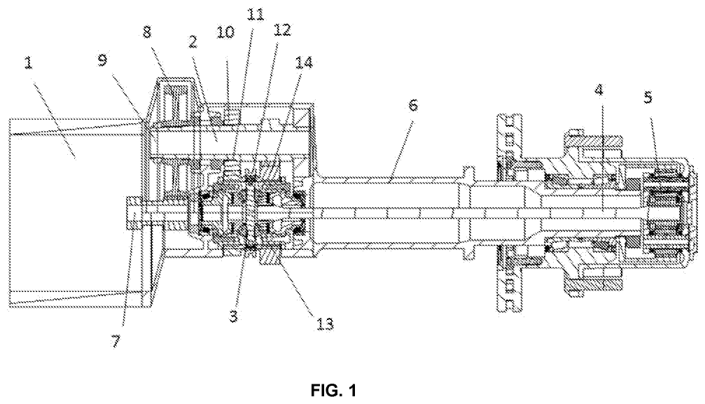

Depicted in FIG. 1 is one preferred embodiment of the electric axle assembly. The electric axle assembly 100 includes a motor/generator 1, an axle housing 6, a differential assembly 3, an axle half shaft 4, a two-speed transmission 2, and a wheel end.

The electric axle assembly is part of an axle assembly for a motor vehicle in general including a pair of wheels drivingly connected on one end of axle half shafts, respectively. It can be appreciated that the pair of wheels form a pair of driving wheels for the motor vehicle. In some embodiments, the vehicle may have a pair of front driving wheels, a pair of back driving wheels, or two pairs of front and back driving wheels.

The motor/generator(s) can be energized by electricity and output rotational movement and torque. In some embodiments, the electricity is provided by a battery pack. In some embodiments, the electric motor acts as an electric generator during brake operation of the electric vehicle for converting braking force into electricity.

In some embodiments, the differential assembly 3 is a common differential gear set implemented to transmit rotational power. In some embodiments, the differential assembly includes a differential housing and a differential gear arrangement disposed in the differential housing with the two axle half shafts extending in axially opposites directions therefrom. The differential gear arrangement is drivingly connected to the axle half shafts respectively. In turn, the axle half shafts are drivingly coupled to wheels via suitable coupling means.

The electric motor/generator 1 is drivingly connected an output/rotor shaft 7 having an output gear 7a rotatingly coupled thereto. The output gear 7a meshingly engages with a countershaft gear 8.

In some embodiments, the two-speed transmission 2 is housed in the axle housing 6 along with the differential assembly 3. The two-speed transmission 2 is coupled to the differential assembly 3.

In some embodiments, the axle assembly further includes a wheel end reduction gear set 5 drivingly connected to the axle half shaft 4 and a wheel. In some embodiments, the wheel end reduction gear set 5 is a planetary gear set.

The countershaft gear 8 is rotationally coupled to a countershaft 9.

In some embodiments, the output shaft 7 is an axle-cavity gear shaft which is connected with the differential assembly 3.

In some embodiments, the axle half shaft 4 passes through the shaft cavity of the output shaft 7 and the differential assembly 3, optionally the wheel end reduction gear set 5, and the wheel ends which are connected sequentially to the axle half shaft 4.

The electric motor/generator 1 is drivingly connected to the output shaft 7 which is connected to the differential assembly 3 and the axle half shaft 4 through the cavity of the output shaft 7.

In some embodiments, the two-speed transmission 2 includes the countershaft 9 and countershaft gear 8 mounted on the countershaft 9 and a two-speed gear 10 rotatingly coupled to the countershaft 9. The countershaft gear 8 is mounted on the countershaft 9 axially between the motor/generator 1 and the two-speed gear 10.

The motor output gear 7a drives the countershaft gear 8 to transmit the power to the countershaft 9.

The output shaft 7 of the motor/generator 1 is arranged on axially on the same line with the axle haft shaft 4. The countershaft 9 is parallel to the output shaft 7 and the axle half shaft 4. In some embodiments, the differential assembly 3 includes a set of differential gears on a gear shaft, a first driven gear 11, a coupling sleeve 12 and a second driven gear 14. The first driven gear 11 and second driven gear 14 are rotatingly connected to the axle half shaft 4.

The two-speed gear 10 is selectively engaged respectively with the first driven gear 11 and the second driven gear 14.

The coupling sleeve 12 selectively couples the first driven gear 11 and the second driven gear 14 to the two-speed gear 10 depending on the desired gear selection.

In some embodiments, an electric shift actuator drives a fork to move the coupling sleeve 12 axially; however, other coupling devices and actuators can be used.

When the coupling sleeve 12 moves axially to the left, the first driven gear 11 engages the two-speed gear 10 and with the differential housing 13 synchronously rotates the axle half shaft 4 transmit powers to the connected wheel end, while the differential assembly 3 through another axle half shaft (not shown) will power transmission to the other wheel end (not shown).

When the coupling sleeve 12 is moved axially to the right, the second driven gear 13 is meshingly engaged with the two-speed gear 10 and with the differential housing 13 synchronously rotates the axle half shaft 4 and the wheel end connected thereto while the differential assembly 3 through another axle half shaft (not shown) will power transmission to other wheel end (not shown).

In some embodiments, the motor/generator 1 is connected to the axle housing 6 with a common load-bearing structure.

In some embodiments, the axle housing 6 includes a bearing housing bores through which the two-speed transmission 2 and the differential assembly 3 are supported.

The bearing housing bores include a bearing housing bore for two-speed transmission housing portion and a bearing housing bore on the central axis of the axle housing for the differential assembly.

The bearing housing bore of the two-speed transmission housing portion supports a two-speed transmission guide bearing, a head bearing and a tail bearing.

The bearing housing bore on the central axis of the axle housing supports bearings at both ends of the differential assembly to support the differential assembly.

In some embodiments, the motor/generator 1 is connected directly with axle housing 6.

The motor/generator 1 transmits power, through the motor output gear 7, the differential assembly 3, axle haft shaft 4, and, optionally, the wheel end reduction gear set 5 to both sides of the wheel end, the cancellation of the bevel gear so that the power input and output end of the same axis, so the power output smooth and high efficiency. The use of two-speed transmission 2 allows the motor/generator 1 to maintain a high efficiency operating range, reducing energy consumption.

In some embodiments, the operation of the axle assembly is controlled by a controller (not shown) connected thereto. The controller may be the vehicle ECU (electronic control unit), a sub-module in the vehicle ECU, an individual controller communicated with the vehicle ECU or the like. The controller can receive commands from the operator of the motor vehicle including information about operations to the gearshift, the acceleration pedal and other pedals as well as other related information, and then controls the electric motor/generators to rotate in a desired direction at a desired speed. In some embodiments, the controller controls the shift fork and coupling sleeve movement.

1. An electric axle assembly comprising:
an axle housing;
a motor/generator having an output shaft drivingly connected thereto, wherein the output shaft has an output gear rotatably mounted thereon;
a differential assembly housed in a differential housing and drivingly connected to a pair of axle half shafts having a pair of wheels attached to the ends thereof; and
a two-speed transmission housed in the axle housing and drivingly connected to the output gear and the differential assembly,
wherein the output shaft is drivingly connected to the motor/generator and the differential assembly.

2. The electric axle assembly of claim 1, wherein the two-speed transmission includes a countershaft having a countershaft gear rotatably mounted thereon and a two-speed gear rotatably mounted on the countershaft, and
wherein the countershaft gear is meshingly engaged with the output gear.

3. The electric axle assembly of claim 2, wherein the differential assembly includes a first driven gear rotatingly mounted on the axle half shaft, a second driven gear rotatingly mounted on the axle half shaft and a coupling sleeve, and
wherein the two-speed gear selectively meshes with the first driven gear and the second driven gear.

4. The electric axle assembly of claim 1, wherein the output shaft, the axle half shafts and the countershaft are parallel to each other.

5. The electric axle assembly of claim 1, further comprising a wheel end reducing gear set drivingly attached to the axle half shaft and the wheel.

6. The electric axle assembly of claim 5, wherein the wheel end reducing gear set is a planetary gear set.
